(19) United States
(12) Patent Application Publication
(10) Pub. No.: US 2015/0168235 A1
(43) Pub. Date: Jun. 18, 2015

(54) Multi-lead measurement apparatus for detection of a defective temperature-dependent resistance sensor

(71) Applicant: Phoenix Contact GmbH & Co. KG, Blomberg (DE)

(72) Inventor: Fabian Zink, Detmold (DE)

(73) Assignee: Phoenix Contact GmbH & Co. KG, Blomberg (DE)

(21) Appl. No.: 14/415,068

(22) PCT Filed: Jul. 22, 2013
(86) PCT No.: PCT/EP2013/065394

§ 371 Date: Jan. 15, 2015

(30) Foreign Application Priority Data
Aug. 2, 2012 (DE) 10 2012 107 090.3

(51) Int. Cl. G01K 15/00; G01K 7/20

(52) U.S. Cl. CPC G01K 15/007; G01K 7/20

(57) ABSTRACT

A multi-lead measurement apparatus, which has at least two current generation devices that can be turned on alternately, at least two voltage measurement devices, and at least three connection terminals, preferably three, four or five connection terminals, to which the at least two temperature-dependent resistance sensors that are electrically connected to one another can be connected. This multi-lead measurement apparatus furthermore has an evaluation device that is configured for automatically determining the electrical resistances of the resistance sensors, using every possible combination of a two-lead, three-lead, and four-lead measurement, in order to be able to detect a defective resistance sensor.

### FIELD OF THE INVENTION

The invention relates to a multi-lead measurement apparatus by means of which a defective temperature-dependent resistance sensor can be detected.

### BACKGROUND OF THE INVENTION

In process technology, measurement values such as temperature measurement values, for example, are supposed to be determined and transformed in such a manner that they meet the demands according to EN 61508 or EN 13849. Platinum resistance sensors, the ohmic resistance of which changes with a changing temperature, are frequently used in temperature measurement nowadays.

It is known to carry out a two-lead, three-lead or four-lead measurement when measuring electrical resistances. A four-lead measurement is particularly carried out when line resistances and connection resistances can distort the measurement.

Frequently, it is difficult to recognize a defective temperature-dependent resistance sensor. In order to be able to recognize defective temperature-dependent resistance sensors, the measurement results of two of the same platinum resistance sensors are evaluated redundantly, for example, in that the two measured temperatures are compared. Such a known measure is mentioned in DE 20 2004 021 438 U1. In the known redundant evaluation, the resistance of each resistance sensor is determined separately, using a multi-lead measurement, so that double the wiring effort is required for a set of two resistance sensors.

From DE 20 2004 021 438 U1, a measurement arrangement is furthermore known, in which two temperature-dependent resistance sensors, switched in parallel, which each have only two connectors, are connected to four measurement terminals of a measurement data processing system. Furthermore, two current sources that can be turned on are provided. The measurement data system can recognize defective resistance sensors as a function of detected voltage drops over the resistance sensors and of detected currents.

From DE 10 2005 029 045 A1, an apparatus for determining and/or monitoring temperature is known, in which a first temperature sensor is connected to a measurement transformer by way of at least three lines, and a second temperature sensor is connected to it by way of at least two lines. In this connection, one line of the first temperature sensor and one line of the second temperature sensor are connected to the common terminal of the measurement transformer.

### SUMMARY OF THE INVENTION

The present invention is based on the task of creating a multi-lead measurement apparatus for detection of a defective temperature-dependent resistance sensor, which apparatus makes do with reduced wiring effort as compared with previously, and allows automatic measurement of multiple resistance sensors.

### BRIEF DESCRIPTION OF THE DRAWINGS

The invention will be explained in greater detail using multiple exemplary embodiments, in connection with the attached drawings. These show:

FIG. 1 a multi-lead measurement apparatus having three connection lines, and

FIG. 2 a multi-lead measurement apparatus having five connection terminals.

### DETAILED DESCRIPTION

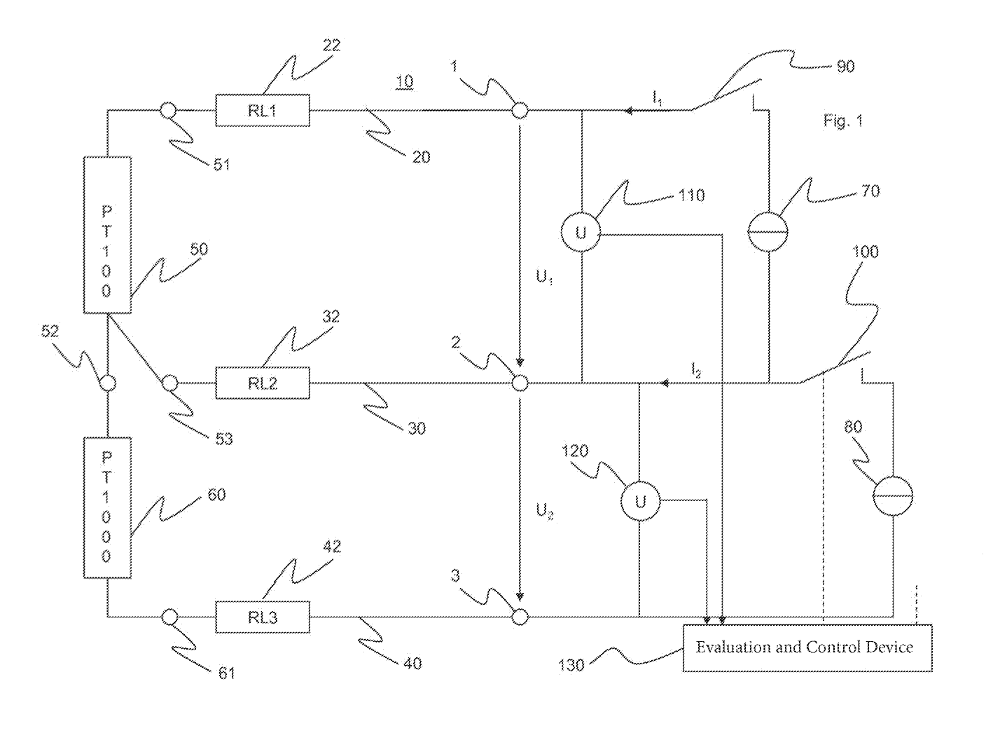

In FIG. 1, a multi-lead measurement apparatus 10 having three connection terminals 1, 2, and 3 is shown, with which a connection line 20, 30 or 40, respectively, is connected. The multi-lead measurement apparatus 10 can therefore also be referred to as a three-lead measurement apparatus. The connection line 20 possesses a line resistance RL1 that is indicated as 22. In similar manner, the connection line 30 has a line resistance RL2 that is indicated as 32, and the connection line 40 has a line resistance RL3 that is indicated as 42. It is advantageous if the line resistances 22, 32, and 42 are the same, at least substantially the same.

Two temperature-dependent resistance sensors 50 and 60, electrically connected in series with one another, are connected to the three connection lines 20, 30, and 40. The temperature-dependent resistance sensors 50 and 60 can be Pt (platinum) sensors. In the present case, the temperature-dependent resistance sensor 50 is a PT100 and the temperature-dependent resistance sensor 60 is a PT1000. This means that the electrical resistances of the two resistance sensors 50 and 60 differ by a factor of 10. The platinum sensor 50 has three connectors 51, 52, and 53, specifically an input connector 51 that is connected to the connection line 20, a first output connector 52 that is connected to an input connector of the platinum sensor 60, and a second output connector 53 that is connected to the connection line 30. The output connector 61 of the platinum sensor 60 is connected to the connection line 40.

A first controllable current generation device 70 is connected to the connection terminals 1 and 2, which device can be turned on and off by way of a switch 90, for example, i.e. can be connected to the connection terminals 1 and 2 or disconnected from the connection terminals. The current generation device 70 is preferably a current source that delivers a constant current I₁, for example. In place of a current source, a voltage source could also be used. Furthermore, a controllable voltage measurement device 110 is switched in between the connection terminals 1 and 2, which device can measure the voltage U₁ present at the connection terminals 1 and 2.

A second controllable current generation device 80 is connected to the connection terminals 2 and 3, which device can be turned on and off by way of a switch 100, for example, i.e. can be connected to the connection terminals 1 and 2 or disconnected from the connection terminals. The current generation device 80 is preferably a current source that delivers a constant current I₂. In place of a current source, a voltage source could also be used. Furthermore, a controllable voltage measurement device 120 is switched in between the connection terminals 2 and 3, which device can measure the voltage U₂ present at the connection terminals 2 and 3.

The output signal of the voltage measurement device 110 and the output signal of the voltage measurement device 120 are passed to an evaluation and control device 130. In an advantageous embodiment, the evaluation and control device 130 requests the measured voltages as needed. It is also conceivable that the evaluation and control device 130 can activate or deactivate the voltage measurement devices in targeted manner. The voltage measurement devices 110 and 120 can be configured as measurement transformers or can be components of a measurement transformer, which converts an analog input signal to a digital output signal, in each instance, and transmits it to the evaluation and control device 130. Furthermore, the evaluation and control device 130 knows the direct currents I₁ and I₂ delivered by the current generation devices 70 and 80.

The evaluation and control device 130 is also connected to the switches 90 and 100. It is configured for opening and closing the two switches 90 and 100 alternately. In other words, one switch is always open, while the other switch is closed. It should be noted at this point that the evaluation and control device 130 can be implemented on a common circuit board and disposed in a housing. Alternatively, the evaluation and control device 130 can also be structured as separate modules.

In a preferred embodiment, the connection terminals 1, 2, and 3, the voltage measurement devices 110, 120, the two current generation devices 70 and 80, and the evaluation and control device 130 are accommodated on or in a housing. The two temperature-dependent resistance sensors 50 and 60 to be checked are then externally connected to the terminals 1, 2, and 3 by the customer.

Using the multi-lead measurement apparatus 10 shown in FIG. 1, it is possible to automatically determine a defective temperature-dependent resistance sensor, using a redundant measurement of electrical resistances and their central evaluation. As compared with a conventional redundant two-lead measurement, in which 2*2 connection lines are required, or a conventional redundant three-lead measurement, in which 2*3 connection lines are required, only the three connection lines 20, 30, and 40 need to be connected for the multi-lead measurement apparatus 10.

In the following, the method of functioning of the multi-lead measurement apparatus 10 shown in FIG. 1 will be explained in greater detail, in which method the electrical resistances RPT100 and RPT1000 of the platinum sensor 50 or of the platinum sensor 60, respectively, are determined by means of a two-lead measurement, in each instance.

Let it be assumed that the switch 90 is closed and the switch 100 is open. Accordingly, a constant current I¹ flows through the connection line 20, the platinum sensor 50, and the connection line 30. Now the voltage U₁ is measured by the voltage measurement device 110 and transmitted to the evaluation and control device 130. From the measured voltage U₁ and the known electrical current I₁, the evaluation and control device 130 determines a value for the electrical resistance RPT100 of the platinum sensor 50, based on the equation U₁/I₁=RL1+RPT1000+RL2, which value is, however, distorted by the line resistances RL1 and RL2.

Subsequently, the switch 90 is opened and the switch 100 is closed, under the control of the evaluation and control device 130. Accordingly, a constant current I₂ flows through the connection line 30, the platinum sensor 60, and the connection line 40. Now the voltage U₂ is measured by the voltage measurement device 120 and transmitted to the evaluation and control device 130. From the measured voltage U₂ and the known electrical current I₂, the evaluation and control device 130 determines a value for the electrical resistance RPT1000 of the platinum sensor 60, based on the equation U₂/I₂=RL2+RPT1000+RL3, which value is, however, distorted by the line resistances RL2 and RL3. The two values are now compared with one another in the evaluation and control device, causing a defective platinum sensor to be detected and indicated, if applicable, if the difference between the two values exceeds a predetermined limit value.

In the following, the method of functioning of the multi-lead measurement apparatus 10 shown in FIG. 1 will be explained in greater detail, in which the electrical resistances RPT100 and RPT1000 of the platinum sensor 50 and of the platinum sensor 60, respectively, are determined by means of a three-lead measurement, in each instance.

Let it be assumed that the line resistances RL1, RL2, and RL3 are the same, at least substantially the same.

Now let it be assumed that the switch 90 is closed and the switch 100 is open. Accordingly, a constant current I¹ flows through the connection line 20, the platinum sensor 50, and the connection line 30. At this moment, the voltages U₁ and U₂ are measured by the voltage measurement device 110 and 120, respectively, and transmitted to the evaluation and control device 130. From the measured voltages U₁ and U₂, as well as the known electrical current I¹, the evaluation and control device 130 determines the electrical resistance RPT100 of the platinum sensor 50 based on a three-lead measurement according to the following equation:

RPT100=(U₁/I₁)−2*(U₂/I₁) (1)

Equation (1) is based on the following deliberation of electrical engineering:

1) As a result of the circuit closed by the switch 90, the following holds true:

U₁=(RL1+RPT100+RL2)I₁ (2)

and

RPT100=(U₁/I₁)−RL1−RL2; (3)

2) Because no current flows through the platinum sensor 60 and the connection line 40 when the switch 100 is open, the following holds true: RL2=U₂/I₁.

With RL1=RL3=RL2=U₂/I₁, Equation (1) follows directly from Equation (3).

Now let it be assumed that switch 90 has been opened and switch 100 has been closed under the control of the evaluation and control device 130. Accordingly, a constant current I₂ flows through the connection line 30, the platinum sensor 60, and the connection line 40. At this moment, the voltages U₁ and U₂ are measured by the voltage measurement device 110 and 120, respectively, and transmitted to the evaluation and control device 130. From the measured voltages U₁ and U₂ as well as the known electrical current I¹, the evaluation and control device 130 determines the electrical resistance RPT1000 of the platinum sensor 60, based on a three-lead measurement, according to the following equation:

RPT1000=(U₂/I₂)+2*(U₁/I₂) (4)

Equation (4) is based on the following deliberation of electrical engineering:

1) As a result of the circuit closed by means of the switch 100, the following holds true:

U₂=(RL2+RPT1000+RL3)I₂ (5)

and

RPT1000=(U₂/I₂)−RL2−RL3; (6)

2) Because no current flows through the platinum sensor 50 and the connection line 20 when the switch 90 is open, the following holds true: RL2=−(U₁/I₂).

With RL1=RL3=RL2=−(U₁/I₂), Equation (4) follows directly from Equation (6).

The electrical resistances RPT100 and RPT1000 determined according to Equations (1) and (4) are subsequently compared in the evaluation and control device, in order to recognize whether at least one of the platinum sensors 50 and 60 is defective. If the electrical resistance RPT1000 is greater by a factor of 10 than the electrical resistance RPT100, both platinum sensors 50 and 60 are defect-free. The tolerance range with regard to the difference between RPT1000 and RPT100, within which no defective platinum sensor is recognized by the evaluation and control device 130, can be established by the customer, for example, and stored as a value in a memory (not shown) of the evaluation and control device 130. In this memory, the values of the currents I₁ and I₂ can also be stored.

It should be noted that the evaluation and control device 130, as described above, can compare the electrical resistances RPT100 and RPT1000 with one another directly for defect recognition. However, it is also conceivable that the electrical resistances RPT100 and RPT1000 that are determined are first converted to the related temperatures in the evaluation and control device 130, and these are subsequently compared.

It is advantageous if the equations indicated above are stored in the memory of the evaluation and control device 130. The corresponding equations are used by the evaluation and control device 130 as a function of the desired two-lead or three-lead measurement, to determine the resistance of the resistance sensors 50 and 60.

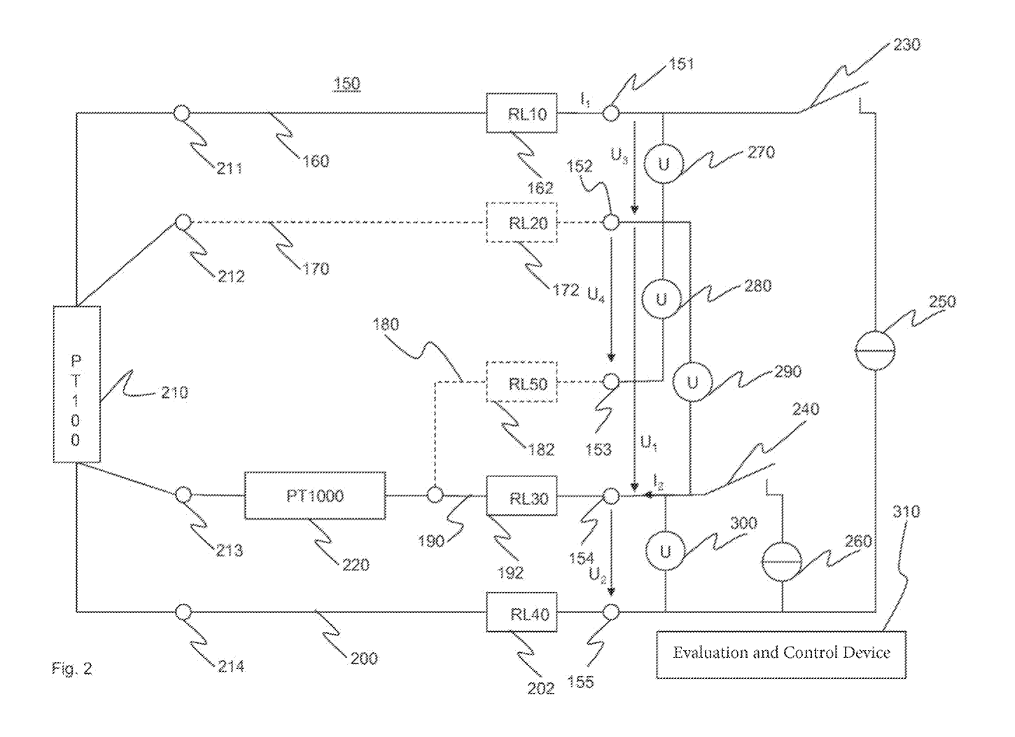

In FIG. 2, a further multi-lead measurement apparatus 150 having 5 connection terminals 151, 152, 153, 154, and 155 is shown as an example, with which terminals a connection line 160, 170, 180, 190, and 200, respectively, can be connected. The connection lines 170 and 180, and the voltage measurement device 280 can be eliminated in the case of a three-lead measurement, as will still be explained below. The connection line 160 possesses a line resistance RL10 that is indicated as 162. The connection line 170 possesses a line resistance RL20 that is indicated as 172. The connection line 180 possesses a line resistance RL50 that is indicated as 182. It should be noted that the connection line 180 could also be replaced by a temperature-dependent resistance sensor. The connection line 190 possesses a line resistance RL30 that is indicated as 192. In similar manner, the connection line 200 possesses a line resistance RL40 that is indicated as 202. It is advantageous if all the line resistances are the same, at least substantially the same.

Two temperature-dependent resistance sensors 210 and 220 that are electrically connected to one another can be connected to the five connection lines 160, 170, 180, 190, and 200. It should be noted at this point that the connection lines 160 to 200 do not have to be separate lines. They can also directly form the connection wires of the resistance sensors 210 and 220. The temperature-dependent resistance sensors 210 and 220 can be Pt (platinum) sensors. In the present example, the temperature-dependent resistance sensor 210 is a PT100 and the temperature-dependent resistance sensor 220 is a PT1000. This means that the electrical resistances of the two resistance sensors 210 and 220 differ by a factor of 10. The platinum sensor 210 has four connectors 211, 212, 213, and 214, with the connectors 211 and 212 being provided on one side and the connectors 213 and 214 being provided on the other side of the platinum sensor 210. The two connectors 211 and 212 are connected to the connection line 160 and the connection line 170, respectively, while the connector 213 is connected to a connector of the platinum sensor 220. The connector 214 of the platinum sensor 210 is connected to the connection line 200. A first controllable current generation device 250 is connected to the connection terminals 151 and 155, which device can be turned on and off by way of a switch 230, for example, i.e. can be connected to the connection terminals 151 and 155 or disconnected from these connection terminals. The current generation device 250 is preferably a current source that delivers a constant current I¹, for example. A second controllable current generation device 260 is connected to the connection terminals 154 and 155, which device can be turned on and off by way of a switch 240, for example, i.e. can be connected to the connection terminals 154 and 155 or disconnected from these connection terminals. The current generation device 260 is preferably a current source that delivers a constant current I₂, for example. A voltage measurement device 270 can be connected between the connection terminals 151 and 152, which device can measure the voltage U₃ present at the connection terminals 151 and 152. A voltage measurement device 280 can be connected between the connection terminals 152 and 153, which device can measure the voltage U₄ present at the connection terminals 152, 153. A voltage measurement device 290 can be connected between the connection terminals 152 and 154, which device can measure the voltage U₁ present at the connection terminals 152 and 154. A voltage measurement device 300 can be connected between the connection terminals 154 and 155, which device can measure the voltage U₂ present at the connection terminals 154 and 155. The output signals of the voltage measurement devices 270, 280,

290, and 300 are added to an evaluation and control device 310. All the voltage measurement devices can be configured as measurement transformers, which each can convert an analog input signal to a digital output signal and transmit it to the evaluation and control device 310. Furthermore, the evaluation/control device 310 knows the direct currents I¹ and I₂ delivered by the current generation devices 250 and 260. These values can also be stored in a memory device (not shown) of the evaluation/control device 310.

The evaluation and control device 310 is also connected to the switches 230 and 240. It is configured for alternately opening or closing the two switches 230 and 240. In other words, one switch is always open, while the other switch is closed. At this point, it should be noted that the evaluation and control device 310 can be implemented on a common circuit board and disposed in a housing. Alternatively, the evaluation and control device 310 can also be structured as a separate module. Furthermore, the evaluation and control device 310 can be configured for activating or de-activating the respective voltage measurement devices as a function of the desired or set multi-lead measurement.

In the embodiments shown in FIG. 2, the connection terminals 151, 152, 153, 154, and 155, the voltage measurement devices 270, 280, 290, and 300, the two current generation devices 250 and 260, as well as the evaluation and control device 310 can be accommodated on or in a housing. The two temperature-dependent resistance sensors 210 and 220 to be checked are then externally connected to the terminals 151, 152, 153, 154, and 155 by the customer.

The multi-lead measurement apparatus 150 shown in FIG. 2 can detect a defective temperature-dependent resistance sensor using an automatic, redundant measurement of electrical resistances and their central evaluation. As compared with a conventional redundant three-lead measurement, in which 2*3 connection lines are required, or a conventional redundant four-lead measurement, in which 2*4 connection lines are required, only four or five connection lines, respectively, need to be connected in the case of the multi-lead measurement apparatus 150.

In the following, the method of functioning of the multi-lead measurement apparatus 150 shown in FIG. 2 is explained in greater detail, in which the electrical resistances RPT100 and RPT1000 of the platinum sensor 210 and of the platinum sensor 220, respectively, are each determined by means of a four-lead measurement.

Again, let it be assumed that the conductor resistances RL10, RL20, RL30, RL40, and RL50 are the same, at least substantially the same.

Now let it be assumed that the switch 230 is closed and the switch 240 is open. Accordingly, a constant current I₁ flows through the connection line 160, the platinum sensor 210, and the connection line 200. Similar to a conventional four-lead measurement, the voltage U₁, which is present between the connection terminals 152 and 154, is measured by the voltage measurement device 290 and transmitted to the evaluation and control device 310. Because of the high-ohm internal resistance of the voltage measurement device 290, only a negligible current flows by way of the connection lines 170 and 190, so that the evaluation and control device 310 can determine the electrical resistance RPT100 of the platinum sensor 210 very precisely from the known current I¹ and the measured voltage U₁, based on a four-lead measurement, according to the following equation:

RPT100=U₁/I₁ (7)

Let it now be assumed that the switch 230 has been opened and the switch 240 has been closed, under the control of the evaluation and control device 310. Accordingly, a constant current I₂ flows through the connection line 190, the platinum sensor 220, and the connection line 200. Using a four-lead measurement, the voltage U₄ of the voltage measurement device 280 present between the connection terminals 152 and 153 is measured and transmitted to the evaluation and control device 310. Because the connection lines 170 and 180 are substantially without current, the evaluation and control device 310 is able to determine the electrical resistance RPT1000 of the platinum sensor 220 from the known current I₂ and the measured voltage U₄, with a very good approximation, according to the following equation:

RPT1000=U₄/I₂ (8)

The electrical resistances RPT100 and RPT1000 determined according to Equations (7) and (8) are subsequently compared in the evaluation and control device 310, in order to recognize whether at least one of the platinum sensors 210 and 220 is defective. If the electrical resistance RPT1000 is greater by a factor of 10 than the electrical resistance RPT100, both platinum sensors 210 and 220 are defect-free. The tolerance range with regard to the difference between RPT1000 and RPT100, within which no defective platinum sensor is recognized by the evaluation and control device 310, can be established by the customer, for example, and stored as a value in a memory (not shown) of the evaluation and control device 310. The values of the currents I₁ and I₂ can also be stored in this memory.

It should be noted that the evaluation and control device 310, as described above, can compare the electrical resistances RPT100 and RPT1000 with one another directly for defect recognition. However, it is also conceivable that the electrical resistances RPT100 and RPT1000 that are determined are first converted to the related temperatures in the evaluation and control device 310, and these are subsequently compared.

The multi-lead measurement apparatus 150 allows an automatic four-lead measurement of the two platinum sensors 210 and 220, although only five connection terminals or five connection lines are present. It should be noted that in the case being described here, only the two voltage measurement devices 280 and 290 are needed. The other two voltage measurement devices 270 and 300 shown can be deactivated by the evaluation and control device 310, for example, or not be present at all. It is also conceivable that the evaluation and control device 310 is programmed in such a manner that it does not evaluate the voltages delivered by the voltage measurement devices 270 and 300.

In the following, the method of functioning of the multi-lead measurement apparatus 150 shown in FIG. 2 will be explained in greater detail, in which the electrical resistance RPT1000 of the platinum sensor 220 can be determined by means of a two-lead measurement, and the electrical resistance RPT100 of the platinum sensor 210 can be determined by means of a four-lead measurement.

In this example, only the connection terminals 151, 152, 154, 155 are required.

Once again, let it be assumed that all the resistances are at least substantially the same.

Furthermore, let it be assumed that the switch 230 is open and the switch 240 is closed. Accordingly, a constant current I₂ flows through the connection line 190, the platinum sensor 220, and the connection line 200. Now the voltage U₂ that is present between the connection terminals 154, 155 is measured by the voltage measurement device 300 and transmitted to the evaluation and control device 310. Using a two-lead measurement, the evaluation and control device 310 determines a value for the electrical resistance RPT1000 of the platinum sensor 220 from the measured voltage U₂ and the known current I₂ based on the equation U₂/I₂=RL30+RPT1000+RL40, which value, however, is distorted by the line resistances RL30 and RL40.

Now the electrical resistance RPT100 of the platinum sensor 210 is also automatically determined, using a four-lead measurement. For this purpose, the switch 230 is closed and the switch 240 is opened. Subsequently, the voltage measurement device 290 measures the voltage U₁ that is present between the connection terminals 152 and 154, and transmits this voltage to the evaluation/control device. The evaluation and control device 310 then determines the electrical resistance RPT100 of the platinum sensor 210 according to Equation (7):

RPT100=U₁/I₁.

Subsequently, the two electrical resistances RPT100 and RPT1000 are compared, in order to be able to detect at least one defective platinum sensor.

It should be noted that the evaluation and control device 310, as described above, can compare the electrical resistances RPT100 and RPT1000 with one another directly for defect detection. It is also conceivable, however, that the electrical resistances RPT100 and RPT1000 that are determined are first converted to the related temperatures in the evaluation and control device 310, and that these are subsequently compared.

The multi-lead measurement apparatus 150 given as an example therefore also allows combined, automatic use of a two-lead and four-lead measurement of the two platinum sensors 210 and 220, although only four connection terminals or four connection lines are present.

In the case described above, only the two voltage measurement devices 290 and 300 will be needed. The other two voltage measurement devices 270 and 280 shown can be deactivated by the evaluation and control device 310, for example, or even not be present at all. It is also conceivable that the evaluation and control device 310 is programmed in such a manner that it does not evaluate the voltages delivered by the voltage measurement devices 270 and 280 in this case.

In the following, the method of functioning of the multi-lead measurement apparatus 150 shown in FIG. 2 will be explained in greater detail, in which the electrical resistances RPT100 and RPT1000 of the platinum sensor 210 and of the platinum sensor 220, respectively, are each determined by means of a three-lead measurement.

For this purpose, the connection terminals 152 and 153 and the voltage measurement device 280 are not needed for measuring a voltage U₄.

Once again, let it be assumed that the conductor resistances RL10, RL30, and RL40 are the same, at least substantially the same.

Now let it be assumed that the switch 230 is closed and the switch 240 is open. Accordingly, a constant current I₁ flows through the connection line 160, the platinum sensor 210, and the connection line 200.

Now the voltage U₁ can be measured by the voltage measurement device 290, the voltage U₂ can be measured by the voltage measurement device 300, and the voltage U₃ can be measured by the voltage measurement device 270, and transmitted to the evaluation and control device 310. From the measured voltages U₁, U₂, U₃ and the known electrical current I¹, the evaluation and control device 310 determines a value for the electrical resistance RPT100 of the platinum sensor 210 according to the equation:

RPT100=(U₃+U₁−U₂)/I₁. (9)

Equation (9) results from the following deliberations:

RL10+RPT100+RL40=(U₃+U₁+U₂)/I₁ with RL10=RL40=U₂/I₁.

Now let it be assumed that the switch 230 has been opened and the switch 240 has been closed under the control of the evaluation and control device 310. Accordingly, a constant current I₂ flows through the connection line 190, the platinum sensor 220, and the connection line 200.

Once again, the voltage U₁ can be measured by the voltage measurement device 290, the voltage U₂ can be measured by the voltage measurement device 300, and the voltage U₃ can be measured by the voltage measurement device 270, and transmitted to the evaluation and control device 310. From the measured voltages U₁, U₂, U₃ and the known electrical current I₂, the evaluation and control device 310 determines a value for the electrical resistance RPT1000 of the platinum sensor 220 according to the equation:

RPT1000=2(U₃+U₁)/I₂−U₂/I₂ (10)

Equation (10) results from the following deliberations:

U₂/I₂=2RL40+RPT1000 with RL40=(U₂−U₁−U₃)/I₂.

The electrical resistances RPT100 and RPT1000 determined according to Equations (9) and (10) are subsequently compared in the evaluation and control device 310, in order to recognize whether at least one of the platinum sensors 210 and 220 is defective. If the electrical resistance RPT1000 is greater by a factor of 10 than the electrical resistance RPT100, both platinum sensors 210 and 220 are defect-free. The tolerance range with regard to the difference between RPT1000 and RPT100, within which no defective platinum sensor is recognized by the evaluation and control device 310, can be established by the customer, for example, and stored in a memory (not shown) of the evaluation and control device 310. The values of the currents I¹ and I₂ can also be stored in this memory.

It should be noted that the evaluation and control device 310, as described above, can compare the electrical resistances RPT100 and RPT1000 with one another directly for defect detection. It is also conceivable, however, that the electrical resistances RPT100 and RPT1000 that are determined are first converted to the related temperatures in the evaluation and control device 310, and these are subsequently compared.

The multi-lead measurement apparatus 150 thereby allows automatic three-lead measurement of the two platinum sensors 210 and 220. It should be noted that in the case described above, only the voltage measurement devices 270, 290, and 300 are required. The voltage measurement device 280 can be deactivated by the evaluation and control device 310, for example, or not be present at all. It is also conceivable that the evaluation and control device 310 is programmed in such a manner that it does not evaluate the voltage delivered by the voltage measurement device 280.

It is advantageous if the equations indicated above are stored in the memory of the evaluation and control device 310. As a function of the desired or set two-lead, three-lead or four-lead measurements, the corresponding equations are used by the evaluation and control device 310 to determine the resistances of the resistance sensors 210 and 220.

A core idea of the invention can accordingly be seen in creating a multi-lead measurement apparatus that has at least two current generation devices that can be turned on alternately, at least two voltage measurement devices, and at least three connection terminals, preferably three, four or five connection terminals, with which the at least two temperature-dependent resistance sensors that are connected to one another can be connected. This multi-lead measurement apparatus furthermore has an evaluation device that is configured for determining the electrical resistances of the resistance sensors automatically and using every possible combination of a two-lead, three-lead, and four-lead measurement.

It is advantageous if a multi-lead measurement apparatus for detection of a defective temperature-dependent resistance sensor is provided, which has at least three connection terminals that are connected to two current generation devices that can be turned on alternately and at least two voltage measurement devices. The current generation devices each deliver a pre-determined, preferably constant current. The at least three connection terminals can be connected to at least two temperature-dependent resistance sensors that are connected to one another, by way of a connection line, in each instance. Furthermore, an evaluation device is provided, which is configured for determining the electrical resistances of at least two temperature-dependent resistance sensors from the pre-determined currents and the voltages that can be measured by the voltage measurement devices, and for detecting a defective temperature-dependent resistance sensor as a function of the electrical resistances that are determined.

Preferably, for this purpose, the resistances of the at least two temperature-dependent resistance sensors that are determined are compared with one another directly, or the electrical resistances that are determined are converted to the related temperatures and then compared.

An advantageous further development provides that the evaluation device is configured for determining the electrical resistances of the at least two temperature-dependent resistance sensors by means of a two-lead or three-lead measurement. The evaluation device can be configured for the purpose of controlling a two-lead or three-lead measurement automatically, by response to mode data input by an operator, for example.

In order to reduce the influence of line resistances and connection resistances during the measurement, preferably four connection terminals are provided, which each can be connected to the at least two temperature-dependent resistance sensors by way of a connection line, with the evaluation device being configured for determining the electrical resistance of the one temperature-dependent resistance sensor by means of a four-lead measurement and the electrical resistance of the other temperature-dependent resistance sensor by means of a two-lead measurement.

Alternatively, once again four connection terminals are provided, which can each be connected to the at least two temperature-dependent resistance sensors by way of a connection line, wherein the evaluation device is configured for determining the electrical resistances of the temperature-dependent resistance sensors using a three-lead measurement, in each instance.

According to a further advantageous embodiment, five connection terminals are provided, which can each be connected to the at least two temperature-dependent resistance sensors by way of a connection line, wherein the evaluation device is configured for determining the electrical resistances of the temperature-dependent resistance sensors by means of a four-lead measurement.

Preferably, the temperature-dependent resistance sensors are coupled thermally and disposed in a housing.

The electrical resistances of the temperature-dependent resistance sensors can be the same.

Alternatively, the electrical resistances of the temperature-dependent resistance sensors can also stand in a pre-determined relationship with one another.

Preferably, the temperature-dependent resistance sensors are platinum sensors.

Furthermore, a control device can be provided for turning on the current generation devices and/or the voltage measurement devices. The evaluation device and the control device can be implemented separately or integrated.

What is claimed is:

1. A multi-lead measurement apparatus for detection of a defective temperature-dependent resistance sensor, having
three connection terminals, which are connected to two current generation devices that can be turned on alternately, and each deliver a pre-determined current, and with at least two voltage measurement devices,
at least two temperature-dependent resistance sensors switched in series, wherein the one temperature-dependent resistance sensor has three connectors and the other temperature-dependent resistance sensor has two connectors,
wherein two of the three connection terminals can be connected to the one temperature-dependent resistance sensor by way of a connection line, in each instance, and the third connection terminal can be connected to the other temperature-dependent resistance sensor by way of a further connection line, and having
an evaluation device that is configured for determining the electrical resistances of the at least two resistance sensors from the pre-determined currents and from the voltages that can be measured by the voltage measurement devices, by means of a two-lead measurement, in each instance, or by means of a three-lead measurement, in each instance, and for detecting a defective temperature-dependent resistance sensor as a function of the electrical resistances that are determined.

2. A multi-lead measurement apparatus for detection of a defective temperature-dependent resistance sensor, having
four connection terminals that are connected, in a pre-determined manner, with two current generation devices that each deliver a pre-determined current, and with two voltage measurement devices,
at least two temperature-dependent resistance sensors switched in series, wherein the one temperature-dependent resistance sensor has four connectors and the other temperature-dependent resistance sensor has two connectors, wherein
three of the four connection terminals can be connected to the one temperature-dependent resistance sensor by way of one connection line, in each instance, and the fourth connection terminal can be connected to the other temperature-dependent resistance sensor by way of a further connection line, and having
an evaluation device that is configured for determining the electrical resistance of the one temperature-dependent resistance sensor from the pre-determined currents and from the voltages that can be measured by the voltage measurement devices, by means of a four-lead measurement, and the electrical resistance of the other temperature-dependent resistance sensor by means of a two-lead measurement, and for detecting a defective temperature-dependent resistance sensor as a function of the electrical resistances that are determined, or
wherein the evaluation device is configured for determining the electrical resistances of the temperature-dependent resistance sensors from the pre-determined currents and from the voltages that can be measured by the voltage measurement devices, by means of a three-lead measurement, in each instance, and for detecting a defective temperature-dependent resistance sensor as a function of the electrical resistances that are determined.

3. A multi-lead measurement apparatus for detection of a defective temperature-dependent resistance sensor, having
five connection terminals that are connected, in pre-determined manner, with two current generation devices that can be turned on alternately and each deliver a pre-determined current, and with two voltage measurement devices,
at least two temperature-dependent resistance sensors switched in series, wherein the one temperature-dependent resistance sensor has four connectors and the other temperature-dependent resistance sensor has two connectors,
wherein three of the five connection terminals can be connected to the one temperature-dependent resistance sensor by way of a connection line, in each instance, and the other two connection terminals can be connected to the connector of the other temperature-dependent resistance sensor by way of a further connection line, in each instance, and having
an evaluation device that is configured for determining the electrical resistances of the one temperature-dependent resistance sensor from the pre-determined currents and from the voltages that can be measured by the voltage measurement devices, by means of a four-lead measurement, in each instance, and for detecting a defective temperature-dependent resistance sensor as a function of the electrical resistances that are determined.

4. The multi-lead measurement apparatus according to claim 1, wherein the temperature-dependent resistance sensors are thermally coupled and disposed in a housing.

5. The multi-lead measurement apparatus according to claim 1, wherein the electrical resistances of the temperature-dependent resistance sensors are the same.

6. The multi-lead measurement apparatus according to claim 1, wherein the electrical resistances of the temperature-dependent resistance sensors stand in a pre-determined relationship with one another.

7. The multi-lead measurement apparatus according to claim 1, wherein the temperature-dependent resistance sensors are platinum sensors.

8. The multi-lead measurement apparatus according to claim 1 further comprising a control device for turning on the current generation devices and/or the voltage measurement devices.
